(19) United States
(12) Patent Application Publication
(10) Pub. No.: US 2021/0013830 A1
(43) Pub. Date: Jan. 14, 2021

(54) Articulating Solar Panel Energy Systems, Methods, and Devices

(71) Applicant: Roccor, LLC, Longmont, CO (US)

(72) Inventors: William Francis, Lyons, CO (US); Dana Turse, Broomfield, CO (US); Bruce Davis, Boulder, CO (US); Kamron Medina, Boulder, CO (US)

(21) Appl. No.: 16/897,479

(22) Filed: Jun. 10, 2020

Related U.S. Application Data
(60) Provisional application No. 62/859,449, filed on Jun. 10, 2019.

(51) Int. Cl. H02S 30/20; H02S 20/30

(52) U.S. Cl. CPC H02S 30/20; H02S 20/30

(57) ABSTRACT

Articulating solar panel energy systems, methods, and devices are provided in accordance with various embodiments. For example, the articulating solar panel energy systems or devices may include multiple modular solar panels and one or more tension cables that support the multiple modular solar panels. The articulating solar panel energy systems or devices may include one or more louvering ties coupled with the multiple modular solar panels such that the one or more louvering ties rotate the multiple modular solar panels. Methods of utilizing the articulating solar panel energy systems or devices are also provided.

### CROSS-REFERENCES TO RELATED APPLICATIONS

This application is a non-provisional patent application claiming priority benefit of U.S. provisional patent application Ser. No. 62/859,449, filed on Jun. 10, 2019 and entitled “ARTICULATING SOLAR PANEL ENERGY SYSTEMS, METHODS, AND DEVICES,” the entire disclosure of which is herein incorporated by reference for all purposes.

### GOVERNMENT LICENSE RIGHTS

This invention was made with Government support under contract 80NSSC18P1969 awarded by NASA. The Government has certain rights in the invention.

### BACKGROUND

Deployable solar arrays systems have often utilized photovoltaic cells bonded to a membrane that may be z-folded while stowed, and then tensioned when deployed. Tension may be carried through the membrane.

There may be a need for new tools and techniques to address a variety of issues that may arise with the use of tension-supported membranes, while providing benefits that may not be achievable with these tension-supported membranes.

### SUMMARY

Articulating solar panel energy systems, methods, and devices are provided in accordance with various embodiments. For example, some embodiments include an articulating solar panel energy system or device that may include multiple modular solar panels and one or more tension cables that support the multiple modular solar panels. Some embodiments include one or more louvering ties coupled with the multiple modular solar panels such that the one or more louvering ties rotate the multiple modular solar panels.

Some embodiments include one or more tensioners coupled with the one or more tension cables. In some embodiments, the one or more tensioners includes at least a constant force spring or a motor to tension the one or more tension cables. Some embodiments include one or more eyelets coupled with each respective modular solar panels from the multiple modular solar panels such that each of the one or more tension cables pass through one or more of the one or more eyelets. Some embodiments include lateral supports coupled with the one or more tension cables.

Some embodiments include a deployer configured to at least deploy or retract the multiple modular solar panels. In some embodiments, the deployer includes a retractable, telescoping mast.

Some embodiments include one or more electrical harnesses coupled with the multiple modular solar panels. In some embodiments, the one or more louvering ties are configured as electrical harnesses. In some embodiments, the one or more louvering ties include an elastic component such that a spacing between adjacent modular solar panels from the multiple modular solar panels is adjustable. In some embodiments, at least one of the one or more tension cables that supports the multiple modular solar panels rotate the multiple modular solar panels.

Some embodiments include a method of articulating solar panels that may include supporting multiple modular solar panels utilizing one or more tension cables. Some embodiments include louvering the multiple modular solar panels. Some embodiments include louvering the multiple modular solar panels utilizing one or more louvering ties coupled with the multiple modular solar panels. Some embodiments include louvering the multiple modular solar panels utilizing at least one of the one or more tension cables. Some embodiments include deploying the multiple modular solar panels utilizing a retractable deployer.

In some embodiments, louvering the multiple modular solar panels includes adjusting an angle of the multiple modular solar panels based on a sun angle with respect to the multiple modular solar panels. In some embodiments, louvering the multiple modular solar panels includes adjusting an angle of the multiple modular solar panels based on at least a wind condition or dust condition with respect to the multiple modular solar panels. In some embodiments, louvering the multiple modular solar panels includes adjusting an angle of the multiple modular solar panels based on at hostile threat to the multiple modular solar panels.

Some embodiments include adjusting a spacing between the multiple modular solar panels utilizing the louvering ties. Some embodiments include rotating the multiple modular solar panels around an axis of the retractable deployer. Some embodiments include louvering the multiple modular solar panels into a retractable configuration and retracting the deployer and multiple modular solar panels. Some embodiments include utilizing the one or more louvering ties as one or more electrical harnesses.

Some embodiments include methods, systems, and/or devices as described in the specification and/or shown in the figures.

The foregoing has outlined rather broadly the features and technical advantages of embodiments according to the disclosure in order that the detailed description that follows may be better understood. Additional features and advantages will be described hereinafter. The conception and specific embodiments disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of different embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A shows a system and/or devices in accordance with various embodiments.

FIG. 1B shows a system and/or devices in accordance with various embodiments.

FIG. 2 shows a system and/or devices in accordance with various embodiments.

FIG. 3A and FIG. 3B show a system and/or devices in accordance with various embodiments.

FIG. 4 shows systems and/or devices in accordance with various embodiments.

FIG. 5 shows a system and/or devices in accordance with various embodiments.

FIG. 6 shows a system and/or devices in accordance with various embodiments.

FIG. 7A and FIG. 7B show system and/or devices in accordance with various embodiments.

FIG. 8A, FIG. 8B, FIG. 8C, and FIG. 8D show systems and/or devices in accordance with various embodiments.

FIG. 9A and FIG. 9B show systems and/or devices in accordance with various embodiments.

FIG. 10 shows a flow diagram of a method in accordance with various embodiments.

### DETAILED DESCRIPTION

This description provides embodiments, and is not intended to limit the scope, applicability, or configuration of the disclosure. Rather, the ensuing description will provide those skilled in the art with an enabling description for implementing embodiments of the disclosure. Various changes may be made in the function and arrangement of elements.

Thus, various embodiments may omit, substitute, or add various procedures or components as appropriate. For instance, it should be appreciated that the methods may be performed in an order different than that described, and that various stages may be added, omitted, or combined. Also, aspects and elements described with respect to certain embodiments may be combined in various other embodiments. It should also be appreciated that the following systems, devices, and methods may individually or collectively be components of a larger system, wherein other procedures may take precedence over or otherwise modify their application.

Articulating solar panel energy systems, methods, and devices are provided in accordance with various embodiments. Some embodiments provide for compact, low-cost, and autonomous deployable solar array systems to support lunar and Martian exploration objective; some embodiments are applicable to space or other applications. Some embodiments are configured for threat mitigation, such as targeted attacks. Some embodiments are compatible with Compact Telescoping Surface Array (CTSA) architecture.

Some embodiments provide for articulating solar panel energy systems, methods, and devices that may replace a z-folded membrane photovoltaic (PV) blanket, as may be found with some CTSA architectures, with a series of modular thin-substrate solar panels that may be supported by a series of cables and/or ties so that they may be tensioned and/or articulated in unison much like “Venetian blind” blades.

The ability to articulate the PV panels may offer unique advantages for operation for different applications, such as on the Martian or lunar surfaces, merely by way of example. The ability to rotate the substrates for direct solar pointing generally enables more efficient power generation and thus may reduce cell density on a deployed area. This reduction in density may help prevent cell shadowing at low sun angles; it may also enable the reduction in cell quantity that may lead to lower costs. Some embodiments also reduce deployed mass and stowed volume simply via the absence of additional substrates (i.e., z-folds).

Panel articulation—or feathering—and change in system porosity may reduce interaction with wind and dust accumulation, for example. The low rotational inertia of the blades in the feathering axis also may make impulses or “flicks” for dust mitigation practical. Discretization into many blades may also enable modular design for mass production and ease of replacement. The PV panel technology in accordance with various embodiments is also generally compatible with central column tensioned solar array architectures.

Articulated solar panel energy systems, methods, and devices provided in accordance with various embodiments may provide a variety of innovations that may provide benefits and/or improvements to other solar panel systems. For example, discretization of the blanket into many panels may simplify manufacturing and may provide an opportunity to reduce cost through the mass production of identical panels. Furthermore, the use of discretized panels may offer improved array modularity, as panels may be easily added or subtracted. It may even be possible, within reason, for an astronaut or robotic agent to augment the array with additional panels to accommodate evolving power needs. Similarly, discretized panels, as opposed to a continuous tensioned blanket, may enable an astronaut or robotic agent to either service or replace individual panels while the array is in operation.

Other advantages may include decoupling of the structural load bearing tension elements from the solar cell substrate that may enable the use of more mass and volume efficient tension cables and mechanisms, and the ability to easily tailor tension to achieve a desired deployed stiffness. In contrast, continuous blanket arrays, where tension is generally reacted through the blanket, generally involves considering factors such as membrane tearing or creep under load, as well as changing tension as a function of time and temperature. Panel louvering may offer a second solar panel articulating axis, in addition to axial about the deployable column, which may improve sun tracking at locations other planetary or lunar poles. Furthermore, the ability to louver the panels to be perpendicular to the mast may enable simplistic and autonomous retractability.

Some embodiments utilize variable length and fully retractable central telescoping mast, which may enable the configuration of the articulating solar panels in accordance with various embodiments to be tailored for a wide range of operational scenarios, such as use at different latitudes. Some embodiments replace the continuous membrane blanket with a series of modular thin-substrate solar panels that may be supported by a series of cables.

Some embodiments provide a deployable, retractable, sun-tracking solar array that generates that provide enough power during multiple regimes of operation. Specifically, the solar array in accordance with various embodiments may be deployed and operated in zero gravity, during initial descent, retract for final descent and landing, deploy again on a surface, retract again for ascent, and/or then deploy again in zero gravity

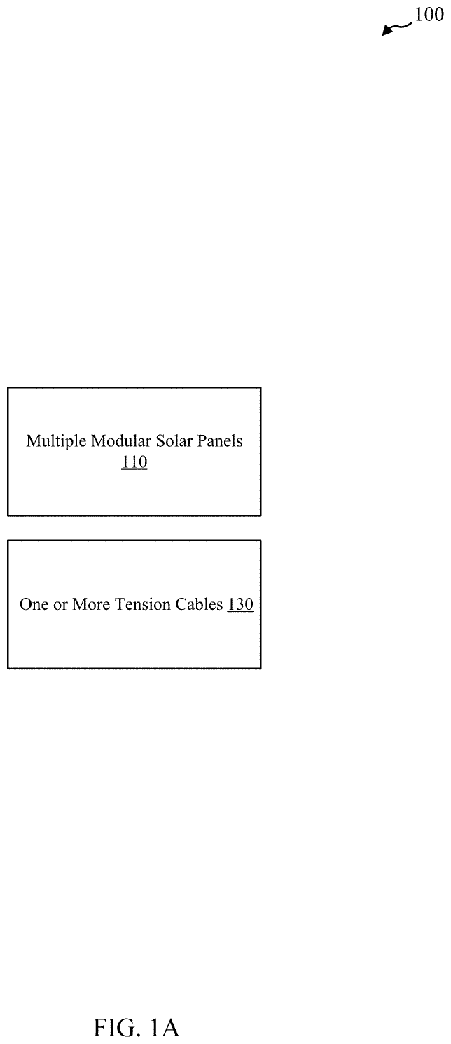

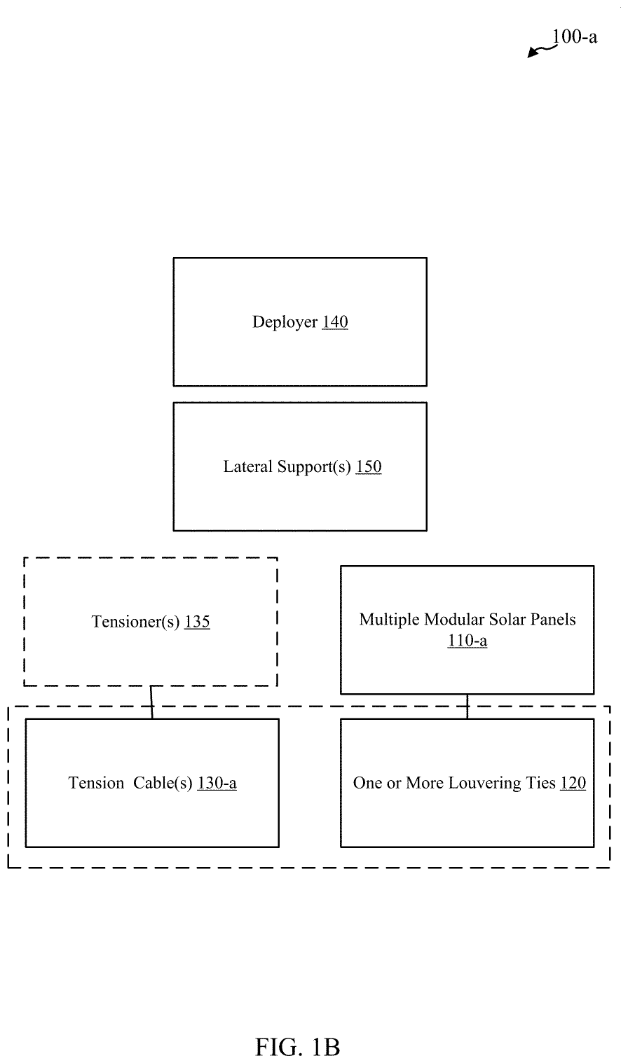

Turning now to FIG. 1A and FIG. 1B, articulating solar panel systems 100 and 100-a are provided in accordance with various embodiments; system 100-a may be an example of system 100. System 100 and system 100-a may include multiple modular solar panels 110, 110-a and one or more tension cables 130, 130-a that support the multiple modular solar panels 110, 110-a. Some embodiments of system 100, such as system 100-a, include one or more louvering ties 120 coupled with the multiple modular solar panels 110-a, such that the one or more louvering ties 120 rotate the multiple modular solar panels 110-a. Louvering ties 120 may include a variety of components, including, but not limited to, ribbons, cables, wires, cords, and/or harness components. Tension cables 130, 130-a may include a variety of components that may be tensioned, including, but not limited to cables, wires, and/or lines.

Some embodiments of system 100 and/or system 100-a include one or more tensioners 135 coupled with the one or more tension cables 130, 130-a. In some embodiments, the one or more tensioners 135 include at least a constant force spring or a motor to tension the one or more tension cables 130, 130-a. Some embodiments include one or more eyelets coupled with each respective modular solar panels from the multiple modular solar panels 110, 110-a such that the one or more tension cables 130, 130-a pass through the one or more eyelets. The one or more eyelets may include one or more apertures. The one or more eyelets may include a variety of components including, but not limited to, grommets, loops, and openings that may be formed as part of the modular panels 110, 110-a and/or coupled with the modular solar panels 110, 110-a. Some embodiments include lateral supports 150 coupled with the one or more tension cables 130-a.

Some embodiments include a deployer 140 configured to at least deploy or retract the multiple modular solar panels 110-a. In some embodiments, the deployer 140 includes a retractable, telescoping mast.

Some embodiments include one or more electrical harnesses coupled with the multiple modular solar panels 110, 110-a. In some embodiments, the one or more louvering ties 120 are configured as electrical harnesses. In some embodiments, the one or more louvering ties 120 include an elastic component such that a spacing between adjacent modular solar panels from the multiple modular solar panels 110-a is adjustable. In some embodiments, at least one of the one or more tension cables 130, 130-a that support the multiple modular solar panels 110, 110-a rotate the multiple modular solar panels 110, 110-a, thus providing for the louvering function, as noted by the optional combining of tension cable(s) 130-a and the one or more louvering ties 120.

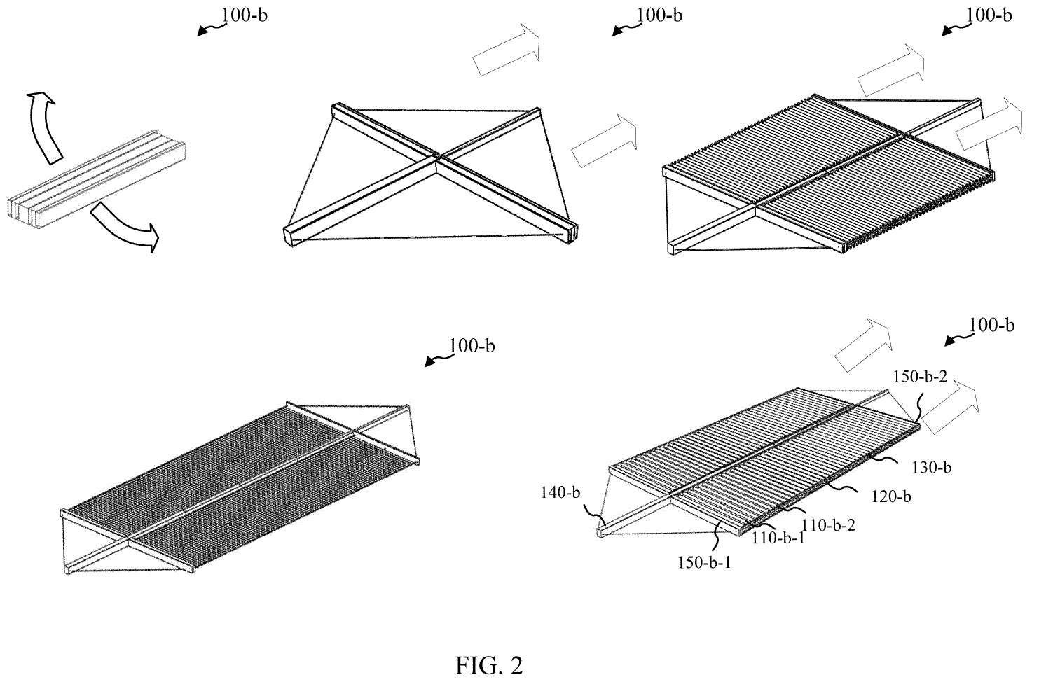

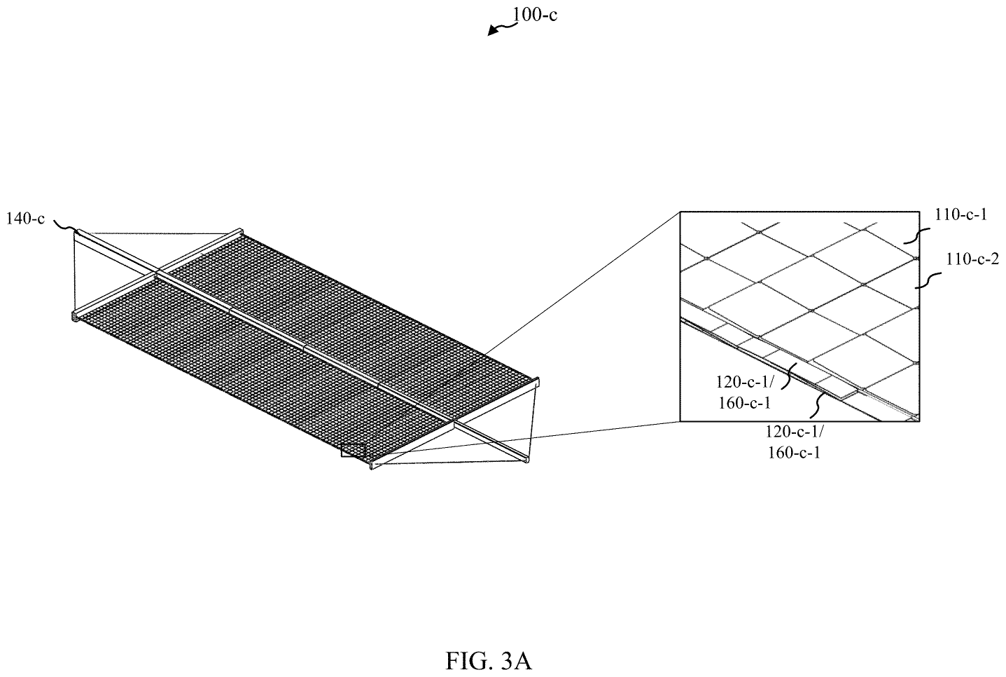

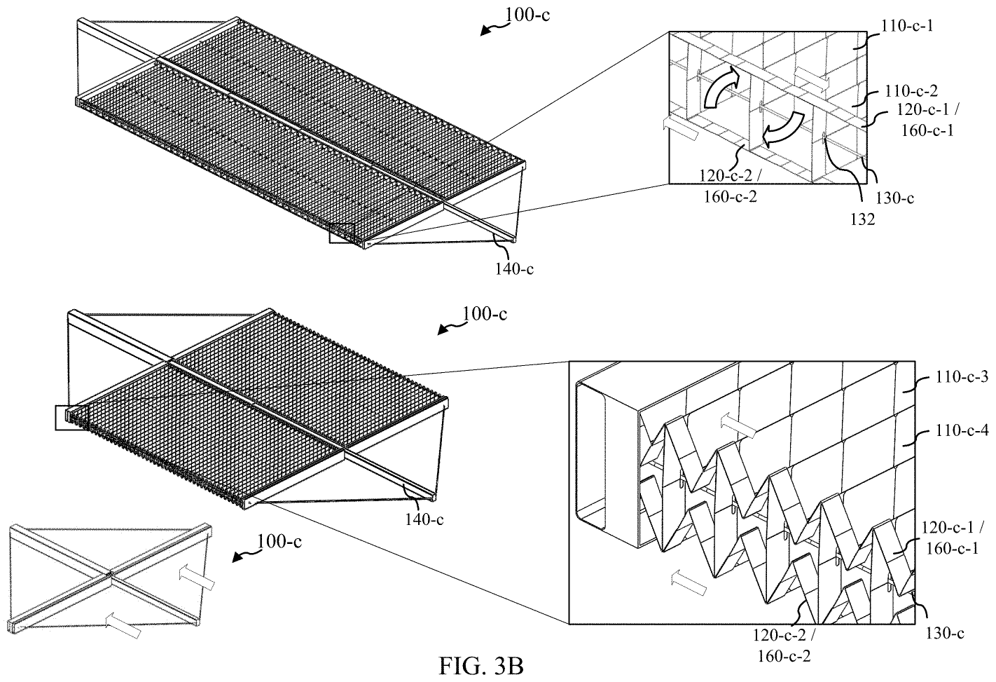

Turning now to FIG. 2, an articulating solar panel energy system 100-b in accordance with various embodiments is provided. System 100-b may be an example of system 100 of FIG. 1A and/or system 100-a of FIG. 1B. FIG. 2 shows system 100-b through a deployment sequence, from the upper left proceeding clockwise to the lower left. System 100-b may provide a resilient solar power generation technology that also may provide advances in stowed volume efficiency and specific power while delivering design adaptability and scalability for a variety of spacecraft and/or surface craft. In some embodiments, system 100-b may be referred to as a flexible substrate resilient array. System 100-b may utilize a single motorized central boom 140-b with reliable deployment and retraction and split blanket canister/spreader-bars 150-b-1, 150-b-2 design, which may minimize tip mass; spreader bars 150-b-1, 150-b-2 may be examples of lateral supports. System 100-b may utilize rapid de-pointing capability of the individual panels for avoidance of threats such as low-power lasers. System 100-b may decouple individual panels, such as panels 110-b-1, 110-b-2, with extremely low inertia and a simple rotational degree of freedom allowing rapid depointing away from a laser or other threat; two modular panels 110-b-1, 110-b-2 are specifically called out, though other panels are also included but may not be specifically called out. One or more louvering ties 120-b may be coupled with the multiple module panels 110-b to facilitate louvering. One or more tension cables 130-b may support the multiple modular panels 110-b. For a more detailed view of louvering ties and/or tension cables, see FIG. 3A and/or FIG. 3B. This louvering of the panels may also be applicable to other applications, such as adjusting for sun angle or to mitigate with respect to wind and/or dust for Martian or lunar applications. System 100-b may include a two degree of freedom (2-DOF) array deployment rather than the 1-DOF, which may be enabled by folding of the retracted blanket and spreader bar assembly against the central boom. The 2-DOF deployment generally allows a more practical stowed form factor for stowage than most competing array architectures and a wider aspect ratio (length to width ratio). Merely by way of example, the lower left image may show a deployed system with a length of 5.3 meters and width of 3.0 meters. These dimensions are merely for example; other dimensions may be utilized. A similar configuration utilizing multiple modular solar panels, tension cable(s), louvering tie(s), and spreader bars or lateral supports is also shown on the left side of the central boom 140-b, but not specifically called out.

FIG. 3A and FIG. 3B show several configurations of an articulating solar panel energy system 100-c in accordance with various embodiments along with several aspects specifically highlighted in more detail. System 100-c may be an example of system 100 of FIG. 1A, system 100-a of FIG. 1B, and/or system 100-b of FIG. 2. System 100-c may incorporate a center telescoping boom 140-c that deploys and tensions a folded solar cell substrate. System 100-c may carry the solar array tension through a series of cables, including cable 130-c, that may support individual thin-substrate solar panels, such as panels 110-c-1, 110-c-2, 110-c-3, 110-c-4, rather than carrying tension through the cell substrate itself; while four panels 110-c-1, 110-c-2, 110-c-3, 110-c-4 are called out, other panels may be included as may be shown in these figures. System 100-c generally enables the panels to remain decoupled so that they can be rotated much like “Venetian blind” blades. Some embodiments are configured to mitigate risk of damage from man-made threats such as a laser attack through rapidly feathering the PV panels in less than one second from threat detection. Some embodiments are configured to different lunar and/or Martian applications, such as adjusting for sun angle and/or for mitigation with respect to wind and/or dust. The use of decoupled modular solar panels 110-c may also allow for the remove and/or replacement of individual modular solar panels.

The position and weight of each blade is generally supported via the tensioned track lines 130-c, in this case fabricated out of a steel cable. The blade feathering angle may be controlled with thin ribbons 120-c-1, 120-c-2, which may be examples of louvering ties, that may be attached to each side of the blade substrate and may run down the entire length of the solar array. In some cases, solar array electrical harness 160-c-1, 160-c-2 may be incorporated into the feathering ribbon 120-c-1, 120-c-2, however this may be dependent on different factors. FIG. 3B also shows the capability of this system to be retracted.

The multiple individual panels, such as panels110-c-1, 110-c-2, 110-c-3, 110-c-4, may be electrically and mechanically integrated into the articulating solar panel system 100-c. The electrical integration and geometrical coordination of the panels may be achieved with the one or more electrical flex harnesses 160-c-1, 160-c-2. The flex-harness style flying leads integrated to the panel sub-assemblies may be what interface to the full length electrical harnesses. Once all of the panels in a sub-assembly are integrated via the electrical harnesses, the sub-assembly may be strung onto the tension cables, such the cable 130-c that is labeled in FIG. 3A and/or FIG. 3B. Each subassembly may be structurally supported by multiple tension cables. As shown in the lower right image of FIG. 3B, the panels 110-c-3, 110-c-4 may slide relative to the tension cables, such as cable 130-c as the cable passes through eyelets, such as eyelet 132; the cables may be tension controlled and spooled in and out during retraction and deployment. The flex harnesses 160-c-1, 160-c-2 may be designed to fan-fold between the panels to enable organized and reliable packaging during retraction. At full deployment, as may be shown in FIG. 3A, the tension cables, such as cable 130-c (obscured from view), are generally highly tensioned and the electrical harnesses 160-c are generally lightly tensioned. When the upper and lower louvering ties 120-c-1, 120-c-2/electrical flex-harnesses 160-c-1, 160-c-2 are pulled in opposite directions (see upper right image of FIG. 3B, for example), the panels 110-c-1, 110-c-2 may be sun pointed as shown in the image of FIG. 3A and are tightly constrained against the tension cables. FIG. 3B may also show eyelet(s) 132, through which tension cable 130-c may pass; the eyelet(s) 132 may be coupled with the respective modular solar panels 110-c. The lower left image of FIG. 3B may show a retracted state. In general, the image of FIG. 3A may show a normal operation configuration, while the upper right image of FIG. 3B may show an example of a de-pointing or orienting of the panels 110-c, which may allow for a high rate avoidance in some cases. The lower right image and lower left image of FIG. 3B may show states of retraction, which may provide for highly protective avoidance in some situations.

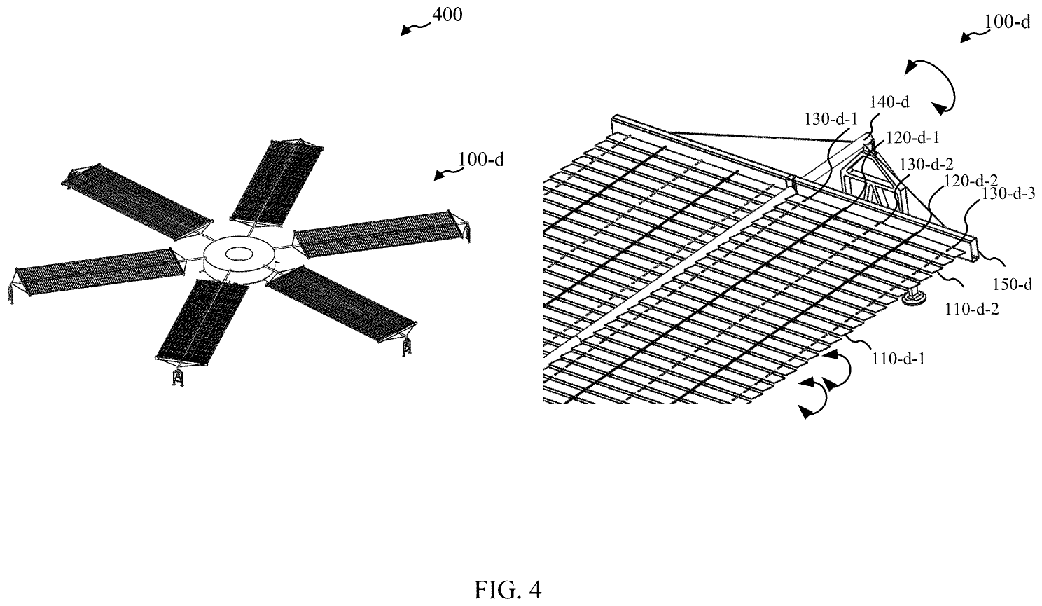

FIG. 4 shows a configuration 400 that may include multiple articulating solar panel energy systems configured around a central hub, including a highlighted portion of articulating panel energy system 100-d in accordance with various embodiments. System 100-d may have a wide variety of applications, including but not limited to lunar or Martian surface exploration. System 100-d may be an example of aspects of system 100 of FIG. 1A and/or system 100-a of FIG. 1B.

System 100-d may include a central telescoping boom 140-d that may be deployed to tension the solar array. The left hand image generally shows a radial configuration for system 400 that includes system 100-d. The right hand image highlights aspects of system 100-d with respect to a series of modular thin-substrate solar panels 110-d-1, 110-d-2 specifically called out supported by a series of tension cables 130-d-1, 130-d-2, 130-d-3. This generally enables the panels to remain decoupled so that they can be articulated in unison much like “Venetian blind” blades as noted elsewhere utilizing one or more louvering ties 120-d-1, 120-d-2. System 100-d may also show one or more lateral supports 150-d.

The ability to articulate the PV panels may offer unique advantages for operation, such as on Martian surfaces. The ability to rotate the substrates for direct solar pointing may enable more efficient power generation and the ability to reduce the cell density on the deployed area. This reduction may help prevent cell shadowing at low sun angles, it also may enable the reduction in cell quantity leading to lower procurement costs. Some embodiments also reduce deployed mass and stowed volume simply via the absence of additional substrates (i.e., z-folds). As noted with the doubled-ended curved arrows along the right hand side of the highlighted portion of system 100-d, panel articulation—or feathering—and change in system porosity may reduce interaction with wind and dust accumulation. The low rotational inertia of the blades in the feathering axis also generally makes impulses or “flicks” for dust mitigation practical. Discretization into many blades may enable modular design for mass production and ease of replacement.

The use of discretized, articulating solar panels or blades, such as blades 110-d-1, 110-d-2, generally allows for a second solar panel articulating axis, in addition to axial (as may be shown with the double-ended curved arrow along the top of highlighted system 100-d with respect to boom 140-d), allowing for direct sun pointing and reduction of cell density of the deployed area. Furthermore, a naturally porous deployed solar panel array that reduce aeroelastic interactions with winds, such as Martian winds, may lead to reduced structural requirements and a decrease in dust accumulation. The small, individual solar substrate blades 110-d-1, 110-d-2 generally have low inertias, allowing for aerodynamic load reduction, and rotational impulse ‘flicks’ that may clean the solar arrays from dust, for example. Decoupling the load bearing tension elements from the solar cell substrates may also allow the use of more efficient, tensioned metallic and/or composite materials enabling a higher deployed stiffness. Furthermore, a discretized solar array into many blades generally simplifies manufacturing to small, individual components and provides opportunity for replacement during assembly or operation. These various benefits may allow for more efficient fabrication, utilization and life extension of the solar cells while also enabling a higher performing support structure. This may yield opportunity for a dramatic reduction in overall cost, power generation, mass, and stowed volume.

After deployment of the solar arrays, there may generally exist several uncertainties and challenges related to optimum array power production. Ground slope, flatness, deployed array shape and orientation, and dust collection has generally motived the implementation of a second rotation axis into the solar array via blade feathering. In addition to improved performance from a more direct sun angle, reductions in mass, packing volume, wind loads, and wind load fatigue can be realized. The highlighted portion of system 100-d shows in particular the structural array pitching axis (as may be shown with the double-ended curved arrow along the top of highlighted system 100-d with respect to boom 140-d) and blade feathering axis (as may be shown with the doubled ended curved arrows along the right hand side of the highlighted portion of system 100-d),that may be achieved by the various embodiments.

Merely by way of example, maximum feathering angles less than 20° may allow for somewhat higher power collection for low-latitude locations and become more significant for higher latitudes. The power-to-mass ratio generally increases with the feathering angle representing an interesting opportunity if P/M (W/kg) is a driving criterion. This may be mainly due to a decreasing mass; feathering at higher angles that generally involves larger gaps between individual panels to avoid self-shadowing at low sun angles (high feather angles) and thus fewer panels, lower mass, and a lower collection area. The porosity of the array may generally be represented by the percentage of open gaps to the total area. The array stowage volume generally decreases with increasing feather angle from the reduction in panels. A benefit of higher porosity may include the reduction in sag on the track wires due to a reduced array mass. For solar arrays on Earth, for example, power increases of only a few percent are highly sought after, especially if they come with a low cost, or for the Martian array, low complexity and low mass as is the case for the dual axis rotation.

In addition to improved power and P/M ratio, improved reduction in wind loading also may arise due to an array with porosity and adaptive panels. In general, wind loading drives may include maximum wind gust and/or fatigue loading. The maximum wind gust generally imparts the maximum (wind) load on the structure, while fatigue loading is generally directly related to cyclic/sporadic changes in wind speed, called the turbulence intensity which is defined as the root-mean-square velocity divided by the mean velocity. Merely by way of example, for a porosity of 0.2 (related to a 30°(50%) feather angle), reductions of approximately 6% and 20% of the drag coefficient and turbulence intensity may be obtained, respectively. For static blades, the drag coefficient is generally linearly proportional to the maximum load, as such only minor load reductions (6%) were expected during this worst-case scenario. A 20% reduction in turbulence intensity, however, may be quite significant from a fatigue perspective: the turbulence intensity is generally linearly proportional to velocity, and wind loading on the structure is generally related to the velocity squared. In addition, fatigue load-life diagrams for composite structures are classically defined through power-law curves. As such, reductions in turbulence intensity of several percent may reduce the fatigue load amplitudes by that percentage squared, which in turn leads to exponentially larger increases in fatigue life.

The introduction of passively adaptive panels in accordance with various embodiments, however, may lead to a much higher reduction in drag coefficient. By optimizing panel size, spacing, and adaptive feathering, porosities near 0.6 may be achieved may significantly reduce drag coefficient and further reduce turbulence intensity to values.

Due to variability in wind loading, adaptive structures may provide a highly effective method for reducing maximum loading conditions and improving fatigue life. Desired solutions generally may be low-weight, low energy use, and not introduce complex mechanisms during deployment or operation. Some articulating solar energy panel systems in accordance with various embodiments are capable of implementing both passive (for normal wind conditions) and active (for extreme storm conditions) aeroelastic control. The passive control may be based on the blade feathering. Regardless of what angle the blades are actively feathered to for the ideal sun orientation, they may be designed to adjust pitch angle due to changing wind speeds via torsion springs connected to their rotational axes. The torsion spring constants may be designed with consideration of blade inertia, expected wind conditions, and natural frequency requirements. Individual springs for each blade element may result in a highly localized response to dynamic pressure changes that may greatly reduce the wind loads by increasing porosity. This passive dynamic response feature may also naturally induce a flutter-like motion of the blades during steady and gusty wind conditions, much like the natural motion of aspen tree leaves in the wind, with the rotational/vibration motion shaking off accumulated dust while also significantly reducing overall drag loads on the array structure. In some embodiments, an active approach may be utilized to remove dust through impulse loads. Mechanical actuators controlled by the feathering ribbon may be used to impulse the blades and (rotationally) flick the dust from their surfaces.

In the event of an impending storm condition, a higher degree of structural adaptivity may be implemented. Active retraction of the solar array blades may be performed during these critical situations, while the track lines and center telescoping column remains deployed and anchored. This feature may be highly advantageous as the wind loads may be minimized, the panels may be protected from abrasion, and the blades will collect minimum dust in their stowed condition.

The right hand image of FIG. 4 also highlights aspects of an articulating solar panel energy system in accordance with various embodiments implemented utilizing tensioned cables 130-d-1, 130-d-2. The deployed array system stiffness and cell sag are generally functions of the applied tension. Minimizing sag in existing blanket configurations generally involve high blanket tension which may make the prone to tears, or the addition of intermediate supports leading to additional complexity. Some embodiments provide for articulating solar panel energy systems that may implement carbon fiber cables/tethers 130-d-1, 130-d-2 that may run through and support the blade substrates as well as create a track on which they deploy/retract, as may be shown in this figure. The tethers are generally capable of extremely high tensile loads and have a low mass, leading to minimal sag. At the same time, the reduction in array collection area may lead to less mass (sag load) on the cables, allowing for reductions in tension. Feathering ribbons 120-d-1, 120-d-2 may allow for the alignment of the blades. In some embodiments, the feather ribbons 120-d-1, 120-d-2 may also be constructed such that they may stretch and contract, which may allow for different spacing between panels. They may facilitate shadow avoidance between panels along with variable porosity for the system.

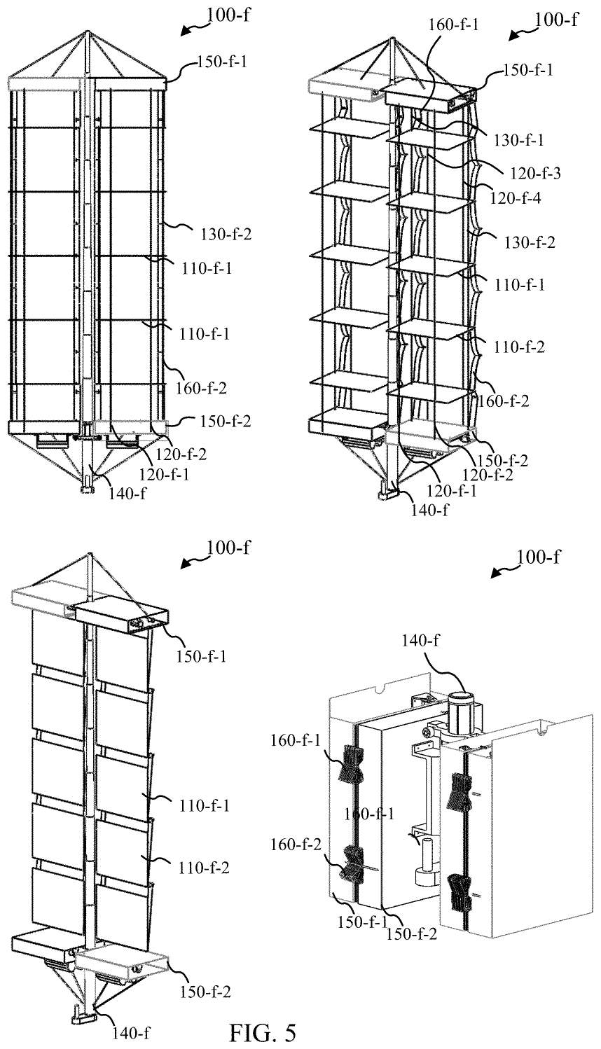

FIG. 5 shows several perspectives of an articulating solar panel energy system 100-f in accordance with various embodiments in various states. System 100-f may be example of aspects of system 100 of FIG. 1A, system 100-a of FIG. 1B, and/or system 100-d of FIG. 4. The lower right shows a stowed state, while the upper sections shows a deployed state with the panels, including panels 11041, 110-f-2 yet to be articulated, while the lower left shows the panels fully louvered, with gaps shown between the panels. The gaps between successful stages may be adjusted in some embodiments through the extension or retraction of a central mast 140-f louvering ties, such as louvering ties 12041, 120-f-2, 120-f-3, 120-f-4, may be facilitate this also, such as through being fabricated from a material that may stretch or contract as the mast 140-f is lengthened or shortened. System 100-f may show flexible electrical harnesses, such as harnesses 16041, 160-f-2, in accordance with various embodiments. In some embodiments, the electrical harnesses 16041, 160-f-2 may be configured to provide the louvering function of louvering ties 12041, 120-f-2. One or more tension cables 13041, 130-f-2 may provide support for the multiple modular solar panels 110-f Lateral supports 15041, 150-f-2 may also be provided.

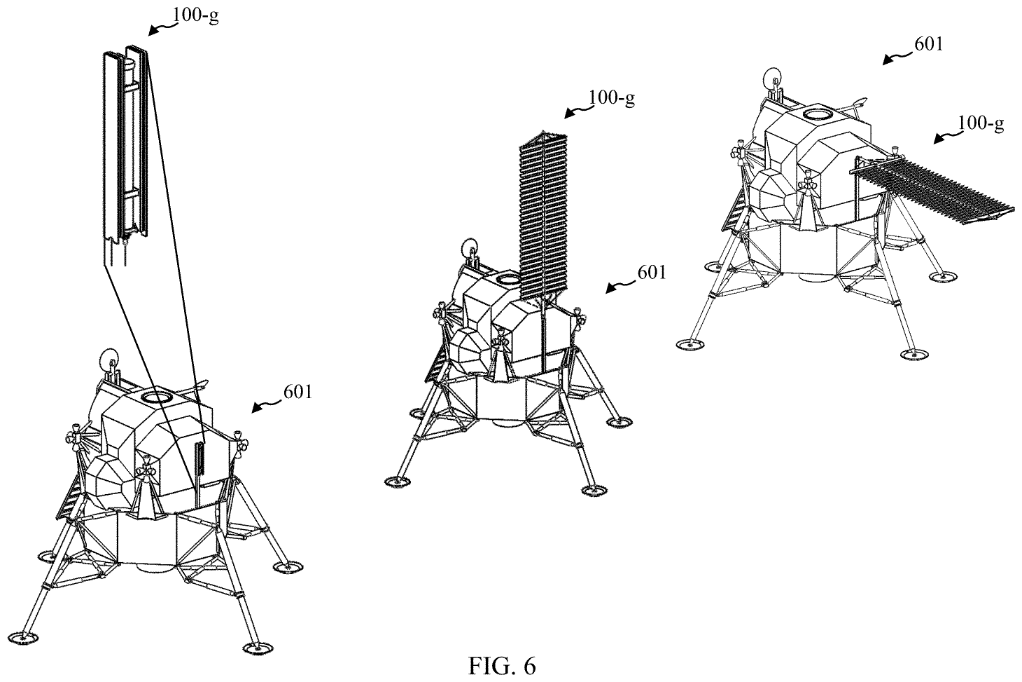

FIG. 6 shows an articulating solar panel energy system 100-g in accordance with various embodiments in various stages of deployment. System 100-g may in particular show a lander embodiment, such as a lunar or Martian lander 601, in both the stowed (left hand image) and deployed configurations (middle and right hand images). FIG. 6 generally shows both a vertical orientation (middle image) and a horizontal orientation (right hand image) for the articulating solar panel system. The horizontal orient may be applicable to equatorial regions, while the vertical orientation may be applicable to polar regions, for example. System 100-g may be example of aspects of system 100 of FIG. 1A, system 100-a of FIG. 1B, system 100-b of FIG. 2, system 100-c of FIG. 3, system 100-d of FIG. 4, and/or system 100-f of FIG. 5.

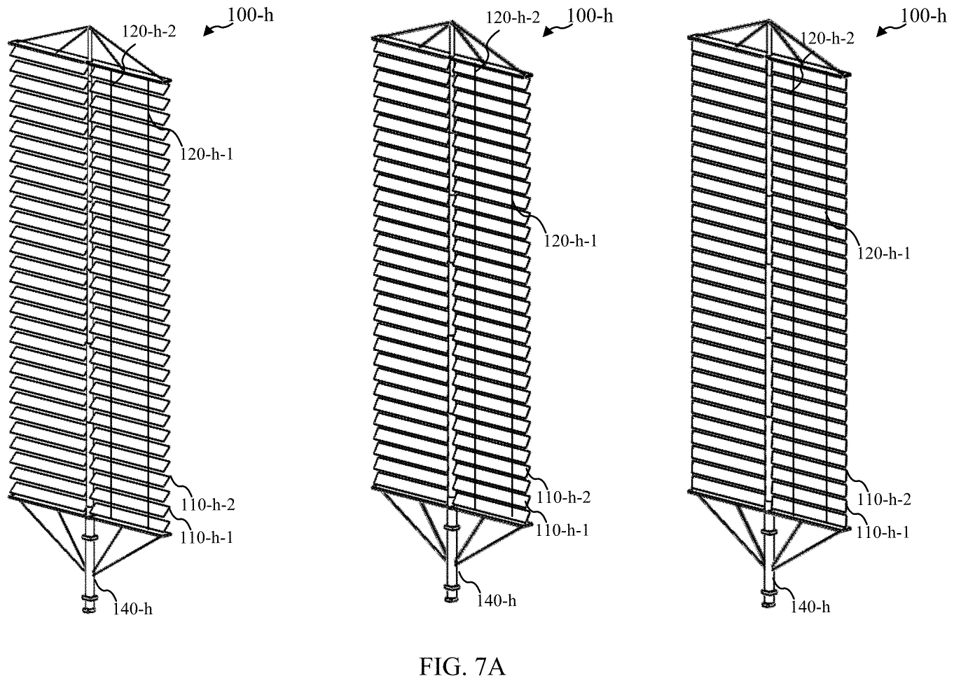

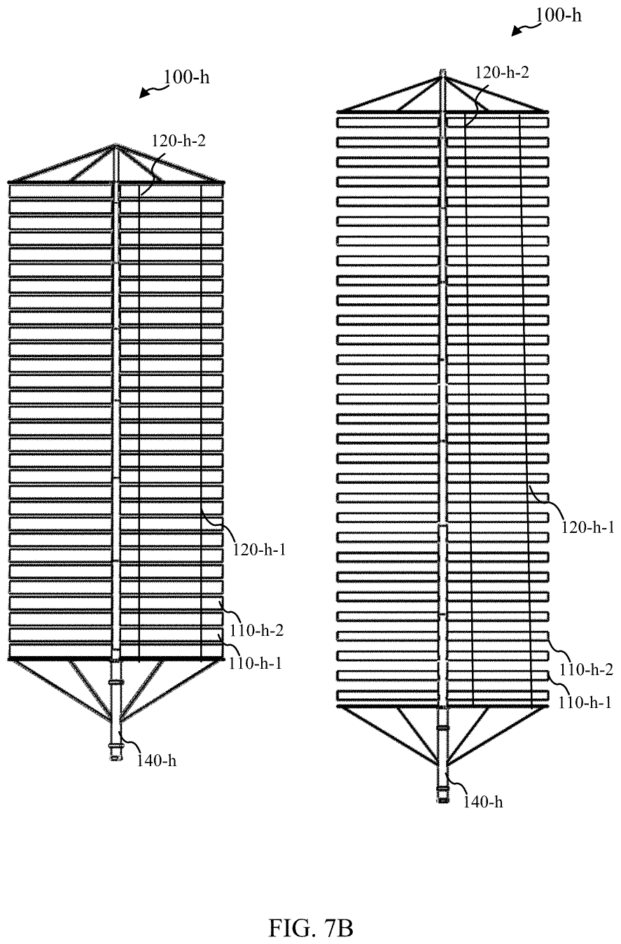

FIG. 7A and FIG. 7B show various configurations of an articulating solar panel energy system 100-h in accordance with various embodiments. System 100-h may be example of aspects of system 100 of FIG. 1A, system 100-a of FIG. 1B, system 100-d of FIG. 4, system 100-f of FIG. 5, and/or system 100-g of FIG. 6. The vertically deployed panels, such as panels 110-h-1, 110-h-2, may be simply articulated about the axis of the central mast 140-h to track the sun across the horizon. As shown, system 100-h may include additional panels 110-h that are not specifically called out. While the discretized, articulating panels 110-h may still be beneficial for a multitude of reasons, dual axis solar tracking through panel articulation may be most relevant at locations other than the polar regions. Some architectures in accordance various embodiments utilize panel articulation, as well as the ability to tailor mast length and array orientation (i.e. vertical versus horizontal deployment), which may enable maximum solar array performance in any operational scenario (i.e. in zero-g or at any planetary or lunar latitude).

FIG. 7A in particular shows examples of how panels 110-h may be louvered based on the angle of solar incidence at different latitudes, for example. From left to right, the panels may be angled for solar incidences of 45°, 30°, and 0°, respectively. Louvering ties, such as ties 120-h-1, 120-h-2, may be coupled with the panels 110-h-1, 110-h-2 to facilitate the angle orientation of the panels. Louvering ties 120-h may be coupled to both front and back long edges of the panels 110-h, though ties may only be shown on the front long edges.

Close attention with respect to the gaps in between panels 110-h at any given location may help ensure that panels 110-h do not shadow one another while tracking the sun. Some embodiments enable this gap to be easily tailored by lengthening or shortening the mast 140-h (see FIG. 7B, for example). The gap may also be facilitated through utilizing the louvering ties, such as louvering ties 120-h-1, 120-h-2, that be fabricated from a material that may stretch or contract as the mast is lengthened or shortened. In FIG. 7B, the left hand image may show a polar configuration, while the right hand configuration may show a maximum extended configuration at 45 degrees latitude.

FIG. 7A and 7B may also include separate tension cables (not shown) to provide support for the modular solar panels 110-h. In some embodiments, the louvering ties 120-h may provide the function of the tension cable, which may be considered as analogous to one or more tension cables being utilized as louvering ties.

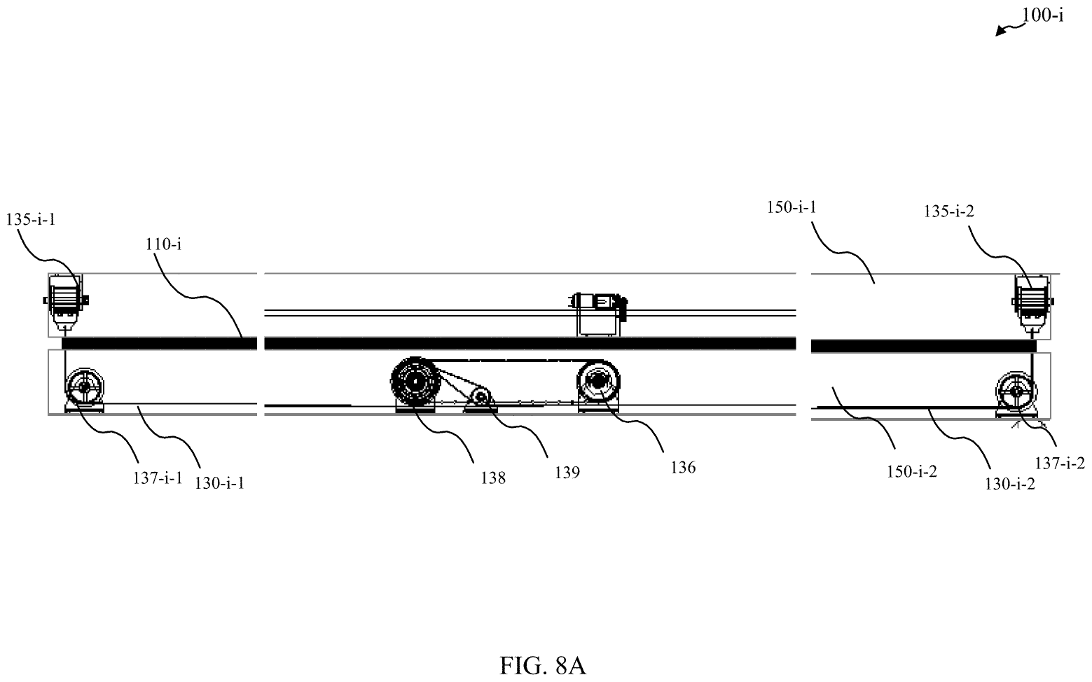

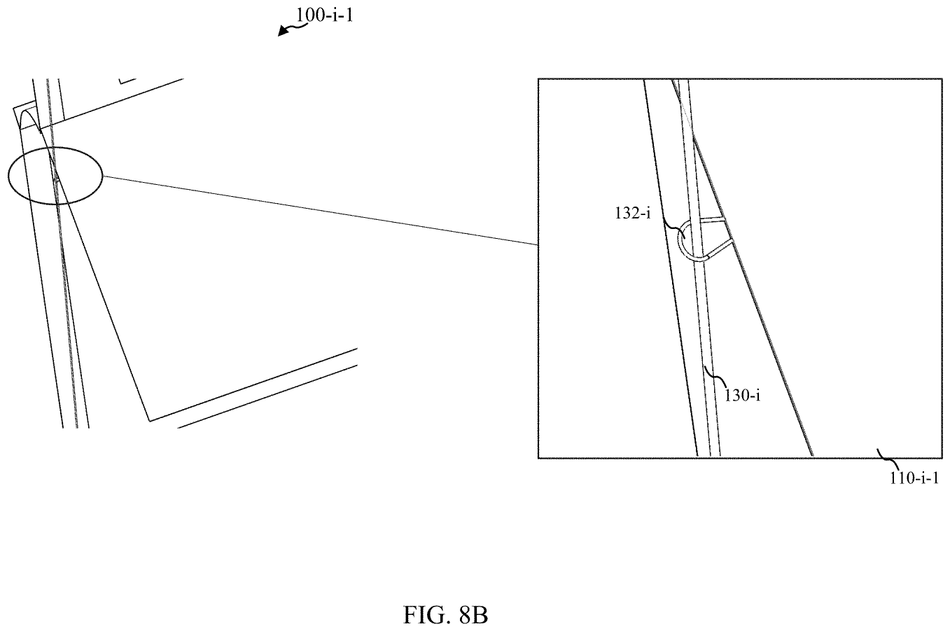

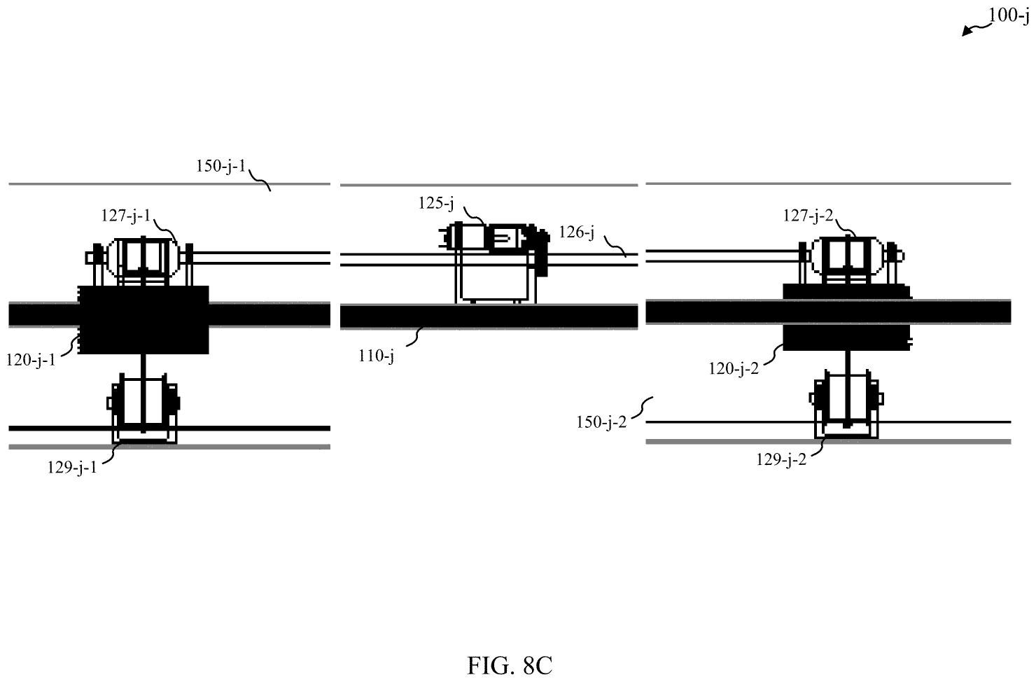

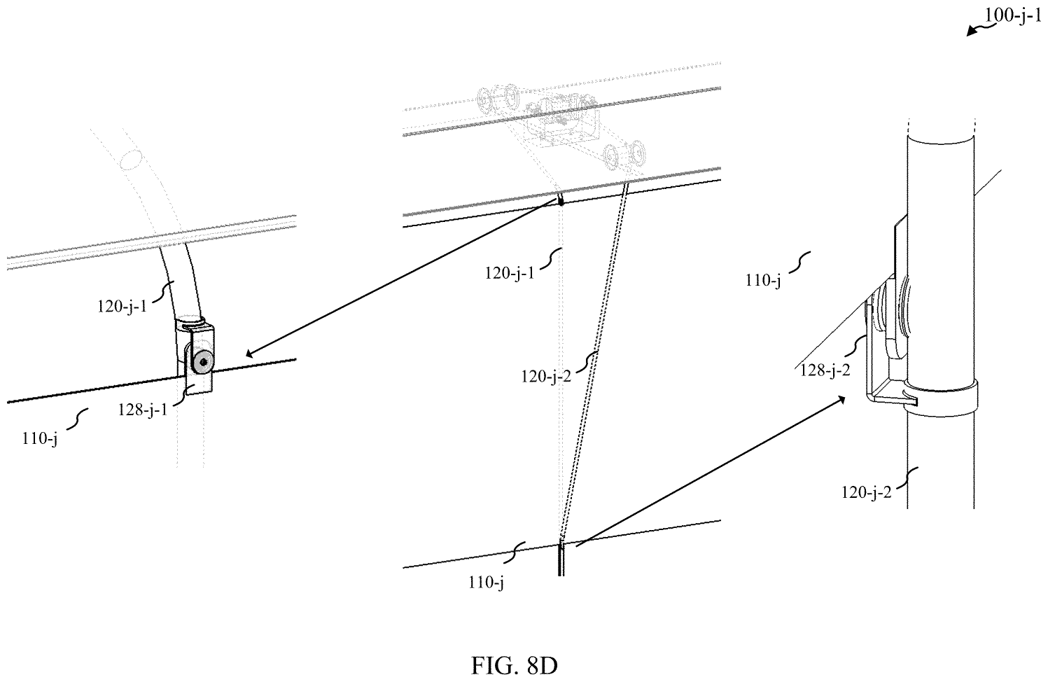

FIG. 8A, FIG. 8B, FIG. 8C, and FIG. 8D shows aspects of different components within various articulating solar panel energy systems in accordance with various embodiments. These components may be utilized with the various systems and/or devices described elsewhere, such as system 100 of FIG. 1A, system 100-a of FIG. 1B, system 100-b of FIG. 2, system 100-c of FIG. 3A and/or FIG. 3B, system 100-d of FIG. 4, system 100-f of FIG. 5, system 100-g of FIG. 6, and/or system 100-h of FIG. 7A and/or FIG. 7B. In particular, these figures may show aspects of tensioning mechanisms and panel louvering mechanisms in accordance with various embodiments. For example, FIG. 8A provides a foreshortened view of a system 100-i that may include a tensioning mechanism components for one side of an array; these components may be referred to as a tensioner. As the telescoping mast deploys, the upper lateral support structure 150-i-1 may separate from the lower lateral support 150-i-2, causing the tension cables 130-i-1, 130-i-2 to unwind from a common spool 138. The constant force springs 135-i-1, 135-i-2 or other tensioners generally maintain a constant tension load (e.g., 100 lbs.) for the entire array throughout the entire deployment. The system components, other than the cables 130-i-1, 130-i-2, may be housed within the lateral support structures 150-i-1, 150-i-2, which may adequately protect the mechanism from contamination, such as dust. Other components shown may include a motor assembly 136, which may include a motor and/or pulley. Cable pulleys 137-i-1,137-i-2, cable spool and spool pulley 138, roller 139, and a stack of multiple modular solar panels 110-i may also be shown. FIG. 8B shows system 100-i-1 with tension cable 130-i that may pass through eyelets 132-i located on either side of the panels 110-i-1 with respect to system 100-i-1. FIG. 8C shows a truncated view of a system 100-j with a louvering mechanism in accordance with various embodiments. This system may be designed to rotate the panels over a range of 90°, from the stowed to operational (sun-pointing) configurations. A centralized motor 125-j may rotate a single rod 126-j up to 90°. Attached to the rod 126-j are slotted cable spools 127-j-1, 127-j-2, one on either side of the motor 125-i j. Guide rollers 129-j-1, 129-j-2 may also be utilized. Panels, such as panel 110-j may be attached to each cable 120-j-1, 120-j-2, respectively, using a ferrules 128-j-1, 128-j-2 (see FIG. 8D showing aspects of system 100-j as system 100-j-1). In the stowed configuration, the louvering ties 120-j-1, 120-j-2 may be folded as shown in FIG. 8C. Upon deployment, the louvering ties 120-j-1, 12-j-2 generally unfold and may set the relative gap between each panel. Once deployed, the louvering mechanism may be used to rotate the panels in unison. As with the tensioning mechanism, all components, with the exception of the cables, may be housed within the upper lateral support structure 150-j-1 and lower lateral support structure 150-j-2 and may be adequately protected from various environmental conditions. One major benefit of the various embodiments is that damaged or failing panels can be easily removed for servicing or replacement, which would not be possible for a continuous tensioned blanket array.

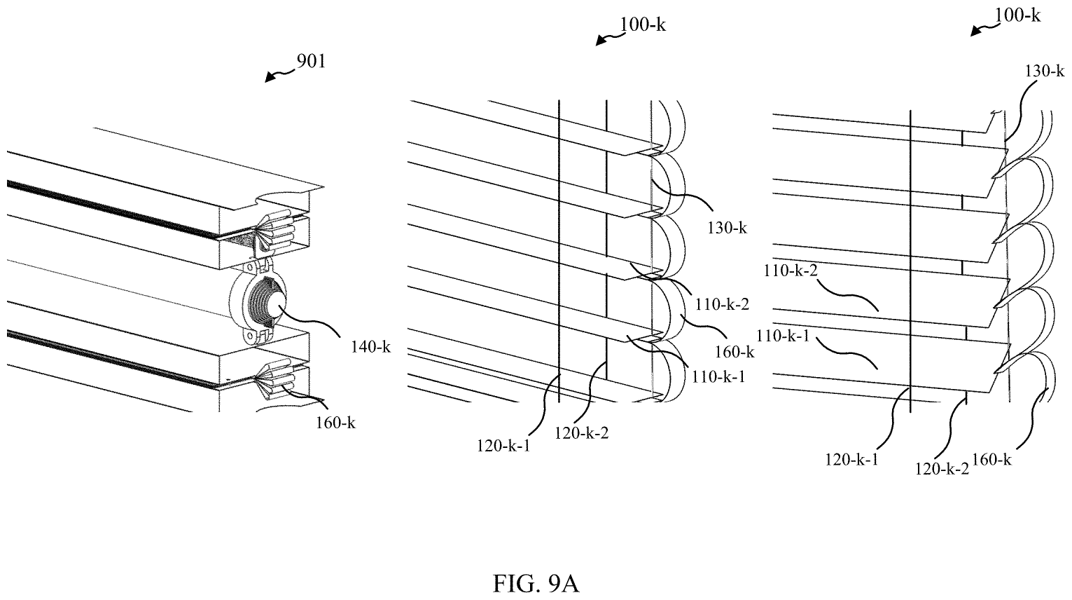

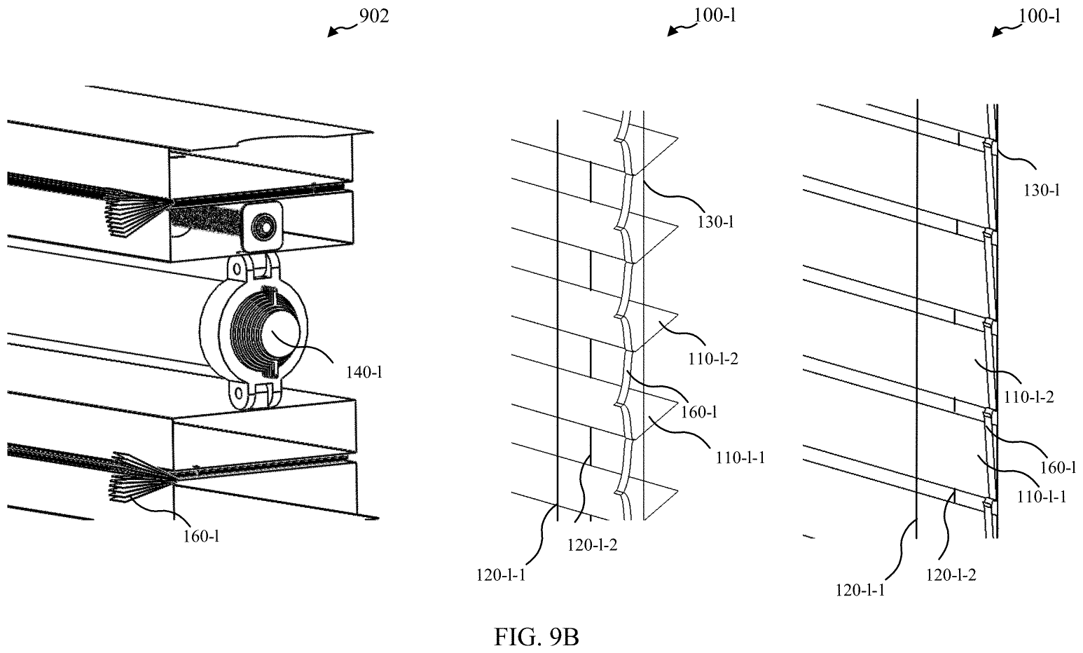

Turning now to FIG. 9A and FIG. 9B, articulating solar panel energy systems 100-k and 100-1, respectively, with various electrical harnesses 160-k, 160-1, in accordance with various embodiments are provided. Components of these systems may be utilized with the various systems and/or devices described elsewhere, such as 100 of FIG. 1A, system 100-a of FIG. 1B, system 100-b of FIG. 2, system 100-c of FIG. 3A and/or FIG. 3B, system 100-d of FIG. 4, system 100-f of FIG. 5, system 100-g of FIG. 6, system 100-h of FIG. 7A and/or FIG. 7B, system 100-i of FIG. 8A and/or FIG. 8B, and/or system 100-j of FIG. 8C and/or FIG. 8D. In general, the individual panels, such as panels110-k-1, 110-k-2 of FIG. 9A or panels 110-1-1, 110-1-2 of FIG. 9B may be connected with a flexible cable harness assemblies160-k, 160-1, respectively, that may collapses when the panels are stowed and expands as they are deployed. The flex sections of the harnesses 160-k, 160-1 generally allow the panels to louver without binding. While a variety of approaches may be utilized with respect to the electrical harnesses utilized in the various embodiments, FIG. 9A and FIG. 9B provide two examples. FIG. 9A shows a simple loop arrangement. When the panels are articulated, the harness 160-k may twist as shown. FIG. 9B shows a second cable harness approach that utilizes a pleated arrangement for the harness 160-1 that may compress nicely and flexes to allow unimpeded louver action of the panels; this configuration may provide for a better stowage envelop. System 100-k also shows a tension cable 130-k; system 100-1 shows a tension cable 130-1. Both FIG. 9A and FIG. 9B show stowed systems 901 and 902 respectively on the left side of the figure; these figures may show telescoping booms 140-k and 140-1, respectively. The middle and right images of FIG. 9A and FIG. 9B show different orientation angles for the modular solar panels.

Some embodiments utilize harness 160-1 to affect louvering of the panels 110-1 respectively. Some embodiments utilize separate louvering ties, such as ties 120-k-1, 120-k-2 or 120-1-1, 120-1-2, that may be separate from the harnesses 160-k or 160-1 or tension cable 130-k or 130-1.

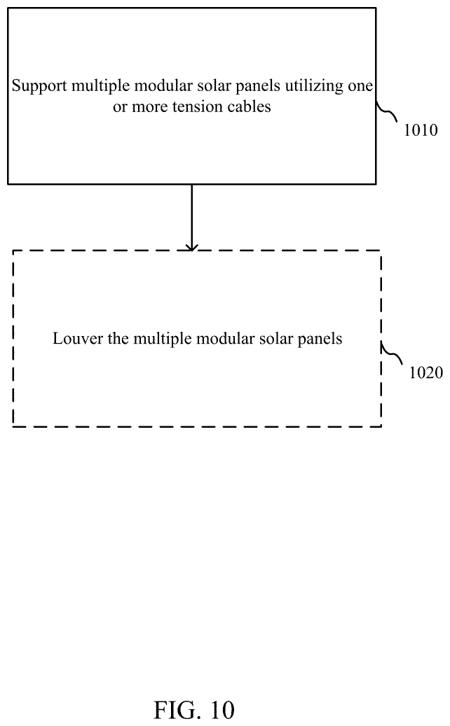

Turning now to FIG. 10, a flow diagram of a method 1000 for articulating solar panels is shown in accordance with various embodiments. Method 1000 may be implemented utilizing a variety of systems and/or devices such as those shown and/or described with respect to FIG. 1A, FIG. 1B, FIG. 2, FIG. 3, FIG. 4, FIG. 5, FIG. 6, FIG. 7A, FIG. 7B, FIG. 8A, FIG. 8B, FIG. 8C, FIG. 8D, FIG. 9A, and/or FIG. 9B.

At block 1010, multiple modular solar panels may be supported utilizing one or more tension cables. Some embodiments include louvering the multiple modular solar panels such as shown with block 1020. Some embodiments include louvering the multiple modular solar panels utilizing one or more louvering ties coupled with the multiple modular solar panels. Some embodiments include louvering the multiple modular solar panels utilizing at least one of the one or more tension cables. Some embodiments include deploying the multiple modular solar panels utilizing a retractable deployer.

In some embodiments, louvering the multiple modular solar panels includes adjusting an angle of the multiple modular solar panels based on a sun angle with respect to the multiple modular solar panels. In some embodiments, louvering the multiple modular solar panels includes adjusting an angle of the multiple modular solar panels based on at least a wind condition or dust condition with respect to the multiple modular solar panels. In some embodiments, louvering the multiple modular solar panels includes adjusting an angle of the multiple modular solar panels based on at hostile threat to the multiple modular solar panels.

Some embodiments include adjusting a spacing between the multiple modular solar panels utilizing the louvering ties. Some embodiments include rotating the multiple modular solar panels around an axis of the retractable deployer. Some embodiments include louvering the multiple modular solar panels into a retractable configuration and retracting the deployer and multiple modular solar panels. Some embodiments include utilizing the one or more louvering ties as one or more electrical harnesses.

These embodiments may not capture the full extent of combination and permutations of materials and process equipment. However, they may demonstrate the range of applicability of the method, devices, and/or systems. The different embodiments may utilize more or less stages than those described.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various stages may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the embodiments.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which may be depicted as a flow diagram or block diagram or as stages. Although each may describe the operations as a sequential process, many of the operations can be performed in parallel or concurrently. In addition, the order of the operations may be rearranged. A process may have additional stages not included in the figure.

Having described several embodiments, it will be recognized by those of skill in the art that various modifications, alternative constructions, and equivalents may be used without departing from the spirit of the different embodiments. For example, the above elements may merely be a component of a larger system, wherein other rules may take precedence over or otherwise modify the application of the different embodiments. Also, a number of stages may be undertaken before, during, or after the above elements are considered. Accordingly, the above description should not be taken as limiting the scope of the different embodiments.

What is claimed is:

1. An articulating solar panel energy system comprising:
a plurality of modular solar panels; and
one or more tension cables that support the plurality of modular solar panels.

2. The system of claim 1, further comprising one or more louvering ties coupled with the plurality of modular solar panels, wherein the one or more louvering ties rotate the plurality of modular solar panels.

3. The system of claim 1, further comprising one or more tensioners coupled with the one or more tension cables.

4. The system of claim 3, wherein the one or more tensioners includes at least a constant force spring or a motor to tension the one or more tension cables.

5. The system of claim 1, further comprising one or more eyelets coupled with each respective modular solar panels from the plurality of modular solar panels such that the one or more tension cables pass through the one or more eyelets

6. The system of claim 1, further comprising a plurality of lateral supports coupled with the one or more tension cables.

7. The system of claim 1, further comprising a deployer configured to at least deploy or retract the plurality of modular solar panels.

8. The system of claim 7, wherein the deployer includes a retractable, telescoping mast.

9. The system of claim 1, further comprising one or more electrical harnesses coupled with the plurality of modular solar panels.

10. The system of claim 2, wherein the one or more louvering ties are configured as electrical harnesses.

11. The system of claim 1, wherein the one or more louvering ties include an elastic component such that a spacing between adjacent modular solar panels from the plurality of modular solar panels is adjustable.

12. The system of claim 1, wherein at least one of the one or more tension cables that support the plurality of modular solar panels rotate the plurality of modular solar panels.

13. A method for articulating solar panels comprising:
supporting a plurality of modular solar panels utilizing one or more tension cables.

14. The method of claim 13, further comprising louvering the plurality of modular solar panels.

15. The method of claim 14, wherein louvering the plurality of modular solar panels utilizes one or more louvering ties coupled with the plurality of modular solar panels.

16. The method of claim 14, wherein louvering the plurality of modular solar panels utilizes at least one of the one or more tension cables.

17. The method of claim 13, further comprising deploying the plurality of modular solar panels utilizing a retractable deployer.

18. The method of claim 14, wherein louvering the plurality of modular solar panels includes adjusting an angle of the plurality of modular solar panels based on a sun angle with respect to the plurality of modular solar panels.

19. The method of claim 14, wherein louvering the plurality of modular solar panels includes adjusting an angle of the plurality of modular solar panels based on at least a wind condition or dust condition with respect to the plurality of modular solar panels.

20. The method of claim 14, wherein louvering the plurality of modular solar panels includes adjusting an angle of the plurality of modular solar panels based on at hostile threat to the plurality of modular solar panels.

21. The method of claim 15, further comprising adjusting a spacing between the plurality of modular solar panels utilizing the louvering ties.

22. The method of claim 17, further comprising rotating the plurality of modular solar panels around an axis of the retractable deployer.

23. The method of claim 14, further comprising:
louvering the plurality of modular solar panels into a retractable configuration; and
retracting the deployer and plurality of modular solar panels.

24. The method of claim 15, further comprising utilizing the one or more louvering ties as one or more electrical harnesses.
